(19) United States
(12) Patent Application Publication
(10) Pub. No.: US 2004/0193295 A1
(43) Pub. Date: Sep. 30, 2004

(54) CONTROL APPARATUS FOR AN INDUSTRIAL MACHINE, A METHOD OF UPDATING A PROGRAM FOR CONTROLLING AN INDUSTRIAL MACHINE, AND INDUSTRIAL MACHINE SYSTEM

(75) Inventor: Yuji Kaneko, Numazu-shi (JP)

Correspondence Address: PILLSBURY WINTHROP, LLP, P.O. BOX 10500, MCLEAN, VA, 22102, US

(73) Assignee: TOSHIBA KIKAI KABUSHIKI KAISHA, Tokyo-To (JP)

(21) Appl. No.: 10/808,494

(22) Filed: Mar. 25, 2004

(30) Foreign Application Priority Data
Mar. 27, 2003 (JP) 2003-088200

(51) Int. Cl. G05B 15/00

(52) U.S. Cl. 700/87

(57) ABSTRACT

An control apparatus for an industrial machine according to an embodiment of the present invention, comprises: a submodule including a first memory of electrically rewritable nonvolatile type to store an industrial machine control program, the submodule executing the industrial machine control program stored in the first memory to control an industrial machine; a read out drive reading out a data for rewriting the industrial machine control program from a memory module; and a main module including a second memory having a rewrite control program stored therein to rewrite the industrial machine control program, and a third memory having a general control program stored therein to control the submodule, in an ordinary mode the main module executing the general control program stored in the third memory to cause the submodule to execute the industrial machine control program and control the industrial machine, in an program rewrite mode the main module executing the rewrite control program stored in the second memory to rewrite the industrial machine control program stored in the first memory, using the data read out by the read out drive.

### CROSS-REFERENCE TO RELATED APPLICATIONS

This application claims the benefit of priority under 35USC § 119 to Japanese Patent Application No. 2003-88200, filed on Mar. 27, 2003, the entire contents of which are incorporated herein by reference.

### BACKGROUND OF THE INVENTION

1. Field of the Invention

The present invention relates to an control apparatus for an industrial machine, which controls industrial machines such as die casting machines, injection molding machines and machine tools or the like, a method of updating a program for controlling an industrial machine, and an industrial machine system.

2. Background Art

The control apparatus that controls industrial machines such as die casting machines, injection molding machines and machine tools or the like includes a main module and submodules typically inserted into a base board, as a basic configuration. The main module manages each of the submodules. On the other hand, the submodules are, for example, motor control modules, counter modules or relay control modules or the like. Each submodule controls an external device (such as a motor, a counter, or a relay or the like) connected thereto. Specifically, each submodule includes an EPROM storing a program to control the external devices, and controls the external devices by using the program.

When updating the program in each submodule, it is necessary in the conventional art to replace the EPROM storing the program therein. In other words, a new program created by using a special development tool is written into an EPROM by a ROM writer, and the EPROM is carried to the customer and the EPROM on the submodule in a control apparatus is replaced with the carried EPROM.

However, well experienced technicians are needed to write the program into the EPROM and replace the EPROMs on the submodule. In addition, it requires labor to write the program into the EPROMs and replace the EPROMs on the submodule. Especially, since the configuration of submodules differs according to the kind of the control apparatus, it becomes very difficult to manage programs in submodules for each of control apparatus. In the case where there is a version change in a program, the management becomes further difficult.

In order to reduce the time and labor required for program update, a method of updating software via a network has also been devised (see, for example, Japanese Patent Application No. 10-198571). This method is a method that makes it possible to update software in a device by operating an apparatus to be updated, by remote control via a network.

If this method were used to update the programs in the submodules, it would be necessary to provide network equipment on a factory having the control apparatus therein and link the control apparatus to the network equipment. This results in an increased cost, and the user is also requested to have knowledge of the network.

### BRIEF DESCRIPTION OF THE DRAWINGS

FIG. 1 is a block diagram showing a configuration of an industrial machine system according to an embodiment of the present invention;

FIG. 2 is a diagram showing an example of a data structure used to update programs in a flash memory;

FIG. 3 is a flow chart showing an operation algorithm of a write control program;

FIG. 4 is a diagram showing an area of a flash memory in a submodule by dividing the area into a program area and a data area; and

FIG. 5 is a diagram showing an example of a data structure used to independently update programs and image data respectively.

### SUMMARY OF THE INVENTION

An control apparatus for an industrial machine according to an embodiment of the present invention, comprises: a submodule including a first memory of electrically rewritable nonvolatile type to store an industrial machine control program, the submodule executing the industrial machine control program stored in the first memory to control an industrial machine; a read out drive reading out a data for rewriting the industrial machine control program from a memory module; and a main module including a second memory having a rewrite control program stored therein to rewrite the industrial machine control program, and a third memory having a general control program stored therein to control the submodule, in an ordinary mode the main module executing the general control program stored in the third memory to cause the submodule to execute the industrial machine control program and control the industrial machine, in an program rewrite mode the main module executing the rewrite control program stored in the second memory to rewrite the industrial machine control program stored in the first memory, using the data read out by the read out drive.

An industrial machine system according to other embodiment of the present invention, comprises: an industrial machine to operate predetermined processings; a submodule including a first memory of electrically rewritable nonvolatile type to store an industrial machine control program to control the industrial machine, the submodule executing the industrial machine control program to control the industrial machine; a read out drive reading out a data for rewriting the industrial machine control program from a memory module; and a main module including a second memory having a rewrite control program stored therein to rewrite the industrial machine control program, and a third memory having a general control program stored therein to control the submodule, in an ordinary mode the main module executing the general control program stored in the third memory to cause the submodule to execute the industrial machine control program and control the industrial machine, in an program rewrite mode the main module executing the rewrite control program stored in the second memory to rewrite the industrial machine control program stored in the first memory, using the data read out by the read out drive.

A method of updating a program for controlling an industrial machine according to other embodiment of the present invention, comprises: in an ordinary mode, a main module executes a general control program stored in a first memory in the main module to cause a submodule connected to the same bus as the main module to execute an industrial machine control program stored in a second memory of electrically rewritable nonvolatile type in the submodule and control an industrial machine, and in a program rewrite mode, the main module executes a rewrite control program stored in a third memory in the main module to make a read out drive which is connected to the same bus read out a data for rewriting the industrial machine control program from a memory module, and rewrites the industrial machine control program stored in the second memory, using the data read out by the read out drive.

### DETAILED DESCRIPTION OF THE INVENTION

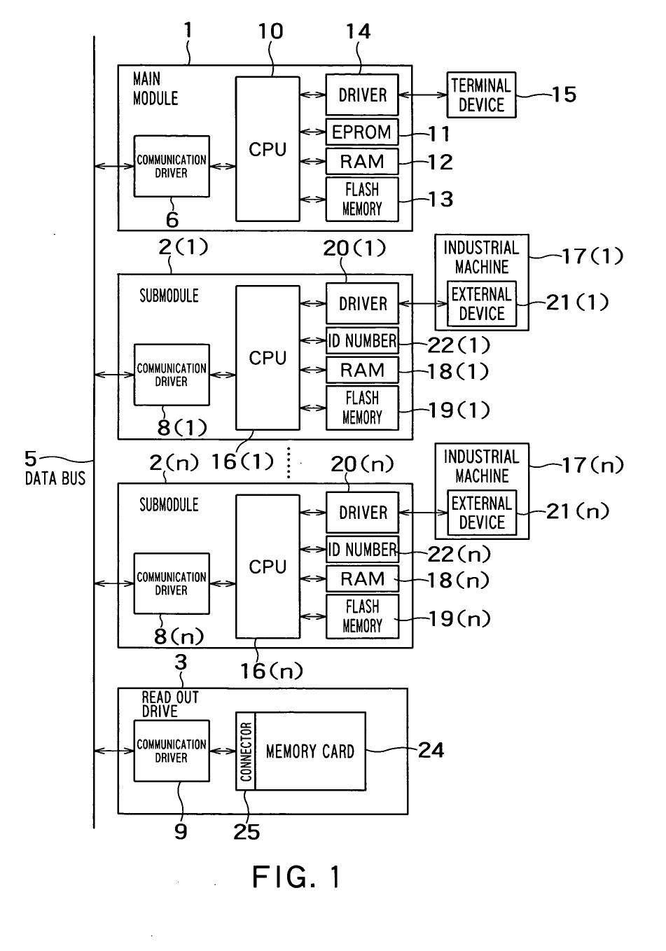

FIG. 1 is a block diagram showing a configuration of an industrial machine system according to an embodiment of the present invention.

As shown in FIG. 1, one main module 1, a plurality of submodules 2(1) to 2(n), and a read out drive 3 are connected to a data bus 5 for data communication. They form a control apparatus.

The main module 1, the submodules 2(1) to 2(n), and the read out drive 3 have connectors, which are not illustrated, and these connectors are inserted into connectors (not illustrated) in the data bus 5. As a result, the main module 1, the submodules 2(1) to 2(n) and the read out drive 3 are electrically connected to the data bus 5.

The main module 1, includes a CPU 10 to implement various kinds of arithmetic operation processing. Furthermore, the main module 1 includes memories of three kinds, i.e., an EPROM (Erasable Programmable Read Only Memory) 11, a RAM (Random Access Memory) 12, and a nonvolatile flash memory 13 on which data can be electrically rewritten (erased and added).

A program to implement the processing of writing a program (write control program or rewrite control program) described later is previously written in the EPROM 11.

A general control program is stored in the flash memory 13 to properly control the whole control apparatus. The general control program includes various instructions and various data, and further includes attribute data such as a version number of the program. The general control program becomes the subject of rewriting in the program write processing.

The RAM 12 is used as a work area when the CPU 10 implements various kinds of arithmetic operation processing.

An input-output driver 14 is connected to the CPU 10. An input-output terminal device 15 such as a keyboard or a display apparatus is connected to the input-output driver 14. The input-output driver 14,for example,adjusts a difference in between the operation speed of CPU 10 and the operation speed of the input-output terminal device 15, and absorbs a difference in electrical characteristics. The CPU 10 exchanges information with the worker in a factory via the input-output driver 14 and the input-output terminal device 15.

As the input-output terminal device 15, for example, a display apparatus having a touch panel may also be used instead of the keyboard and the display apparatus described above.

A communication input-output driver 6 is connected to the CPU 10. The communication input-output driver 6 is connected to the data bus 5 as well. The communication input-output driver 6 converts an output signal of the CPU 10 to a signal suitable for the data bus5, and outputs a resultant signal to the data bus 5. Furthermore, the communication input-output driver 6 monitors data flowing on the data bus 5, acquires data addressed to the main module 1 from the data bus 5, and delivers the data to the CPU 10.

In the same way as the main module 1, the submodules 2(1) to 2(n) also include CPUs 16(1) to 16(n), RAMs 18(1) to 18(n), flash memories 19(1) to 19(n), input-output drivers 20(1) to 20(n), and communication input-output drivers 8(1) to 8(n), respectively.

External devices 21(1) to 21(n) such as motors, counters and relays or the like are connected to the input-output drivers 20(1) to 20(n). The external devices 21(1) to 21(n) are incorporated respectively in industrial machines 17(1) to 17(n) such as die casting machines, machine tools or injection molding machines or the like. Here, each of the industrial machines 17(1) to 17(n) includes one external device. Alternatively, one industrial machine may also include a plurality of external devices (such as motors, counters and relays or the like). For example, one industrial machine may include the external devices 21(1) to 21(n).

Programs of controlling external device 21(1) to 21(n) (external device control programs or industrial machine control programs) are stored in the flash memories 19(1) to 19(n), respectively. Each of the external device control programs includes various instructions and various data, and further includes attribute data such as a version number of the program.

The CPUs 16(1) to 16(n) control the external devices 21(1) to 21(n), i.e., the industrial machines 17(1) to 17(n) by executing the external device control programs, respectively.

Programs for writing new external device control programs (individual write programs or individual rewrite programs) are stored in the flash memories 19(1) to 19(1), respectively.

The submodules 2(1) to 2(n) respectively include module identification mechanisms 22(1) to 22(n) holding ID numbers. The ID numbers can be read out by the CPUs 16(1) to 16(n).

Specifically, a plurality of signal lines are provided in an I/O port (not illustrated) of each of the module identification mechanisms 22(1) to 22(n). Each of the signal lines is pulled up to an output potential of the power supply or grounded. For example, in the case where there are eight signal lines, ID numbers of 2⁸ (=256) kinds can be set in each of the module identification mechanisms 22(1) to 22 (n). Each of the CPUs 16(1) to 16(n) recognizes the ID number of the submodule, i.e., the kind of the submodule by reading potentials respectively of the signal lines in the I/O port.

As mentioned above, the submodules 2(1) to 2(n) include memories of two kinds, i.e., the RAMs 18(1) to 18(n) and the flash memories 19(1) to 19(n), respectively. However unlike the main module 1, the submodules 2(1) to 2(n) do not include an EPROM from the viewpoint of cost reduction.

The read out drive 3 includes a communication input-output driver 9. The read out drive 3 further includes a memory card connector 25. A memory card (memory module) 24 can be inserted into the memory card connector 25.

The memory card 24 is a flash memory module such as a compact flash (registered) or a “Smart Media” (registered) or the like, and it is the same as one generally used in personal computers, especially in notebook computers.

Program data to be newly installed (such as data of a general control program and external device control programs to be newly installed) are previously stored in the memory card 24.

Creation of new programs is implemented by a general purpose personal computer. The created programs are transferred to a memory card inserted into a slot of the personal computer. This memory card is inserted into the memory card connector 25, and is read out by the read out drive 3. In this way, since the program rewriting processing is implemented by using the general purpose memory card, a special development tool or a special medium is not needed.

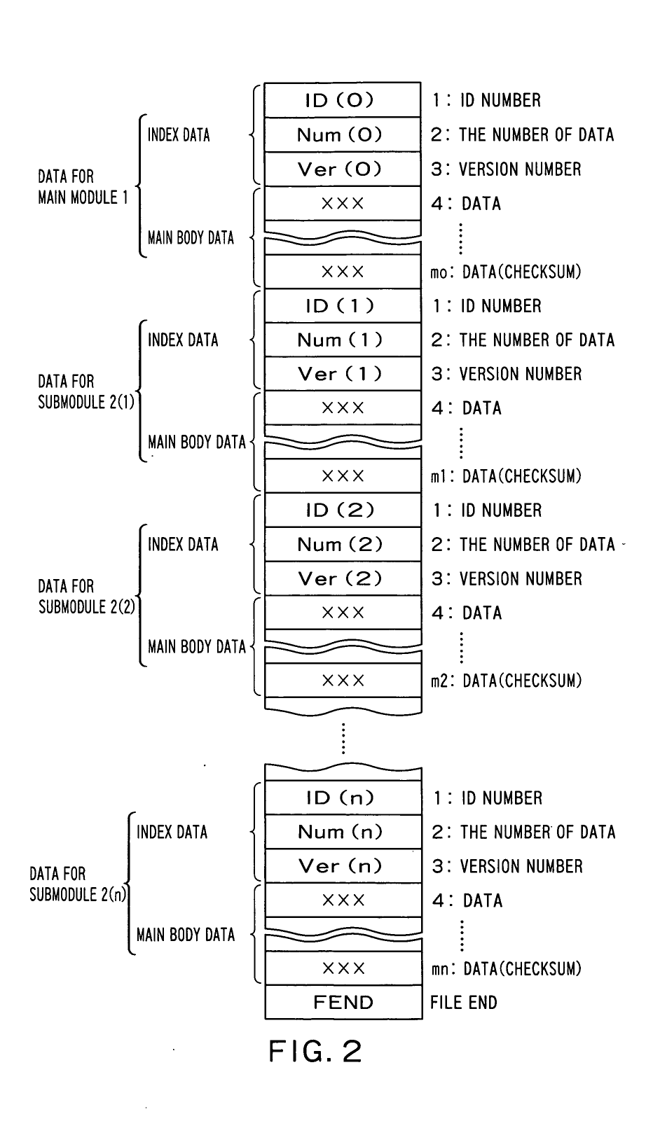

FIG. 2 is a diagram showing a data structure (file) stored in the memory card 24.

This data structure has a new general control program for the main module 1, and new external device control programs for the submodules 2(1) to 2(n). This data structure is formed by sequentially arranging, for example, 8-bit blocks from an address as a predetermined reference. Hereafter, the data structure will be described in further detail.

An ID number representing the kind of a module is stored in a head block (first block) of the data for the main module 1 and the data for the submodules 2(1) to 2(n). In the case of the main module, the ID number is, for example, “0”. In the case of submodules, the ID numbers are the ID numbers set in the above described module identification mechanisms 22(1) to 22(n).

The number of blocks storing main body data (a program to be newly installed) is stored in a block (second block) following the first block. For example, in the case of the data for the submodule 2(1), the number of blocks storing the main body data is “m1-3” as shown in FIG. 2, and consequently “m1-3” is stored in the second block.

A version number of main body data (a program to be newly installed) is stored in a block (third block) following the second block. For example, the version number is “0” in a program created first, and it is incremented each time the program is updated.

Data from the first to third blocks heretofore described are referred to as index data as shown in FIG. 2.

Main body data (programs to be newly installed, i.e., the general control program and the external device control programs) are divided into a plurality of blocks and stored in blocks from a block (fourth block) following the third block to an mxₜₕ (where x=1, 2, . . . n) block.

A symbol “FEND” indicating the end of the data structure (file) is stored after the bottom block mn.

Here, a module into which the programs should be written can be arbitrarily selected from the main module 1 and the submodules 2(1) to 2(n). In other words, update of a program can be implemented only in desired modules by creating the index data and the main body data for only a desired module. For example, it is also possible to create the data structure which includes only the index data and the main body data for the main module and does not include those for the submodules.

Furthermore, a checksum may be stored in the end part of each module data as shown in FIG. 2. The checksum is a numerical value indicating some from bottom digit of a result obtained by adding data contents. By including the checksum, it becomes possible to, for example, display a “write error” when the value of the checksum in the memory card 24 is different from the value of the checksum computed on the base of data written in the flash memory, and write the module data again.

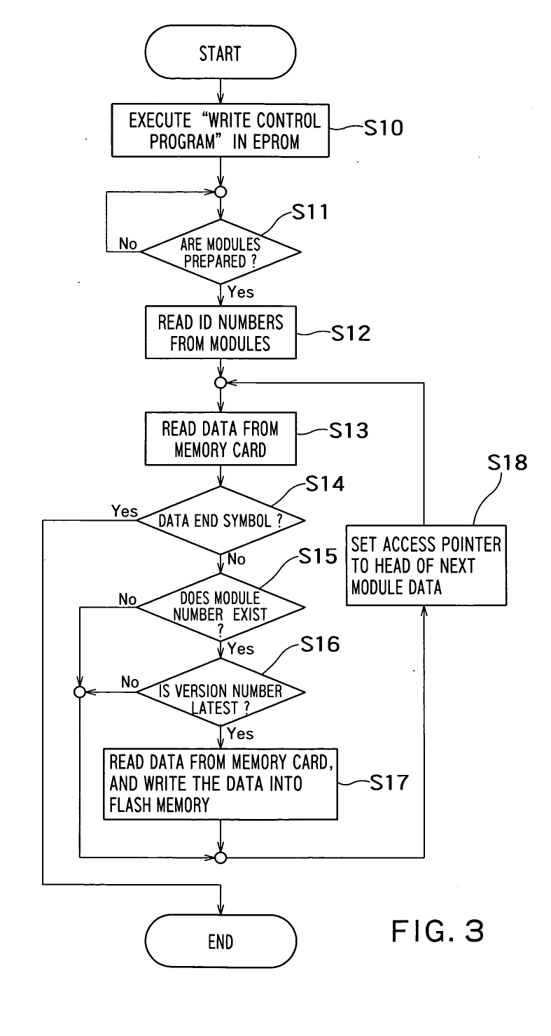

FIG. 3 is a flow chart showing an operation algorithm of the write control program.

The write control program is stored in the EPROM 11 in the main module 1, and is read out and executed by the CPU 10 in the main module 1. Here, it is supposed that programs to be written newly are the general control program and the external device control programs.

First, as shown in step S10 in FIG. 3, the write control program stored in the EPROM l in the main module 1 is executed (step S10). Specifically, first, the memory card 24 storing the index data and the main body data is inserted into the connector 25 in the read out drive 3. If in this state the power supply of the control apparatus is turned on while depressing a specific key (which is provided in the main body of the control apparatus and which is not illustrated), a start program (not illustrated) stored in the EPROM 11 in the main module 1 is executed. The CPU 10 starts readout of the write control program in accordance with the start program. In other words, the write control program is executed.

At this time, the submodules 2(1) to 2(n) start preparations for write processing (step S11). Specifically, the CPUs 16(1) to 16(n) respectively in the submodules 2(1) to 2(n) load individual write programs stored in the flash memories 19(1) to 19(n) into the RAMs 18(1) to 18(n). Upon loading the individual write programs into the RAMs 18(1) to 18(n), the submodules 2(1) to 2(n) sends a preparation completion flag onto the data bus 5. Until the preparation completion flag is sent to the CPU 10, the CPU 10 in the main module 1 waits (“No” of the step S11).

Upon receiving preparation completion flags from the submodules 2(1) to 2(n) (“Yes” of the step S11), the CPU 10 reads out the ID numbers successively from the submodules 2(1) to 2 (n) and grasps the submodule configuration (step S12). Specifically, the CPUs 16(1) to 16(n) respectively in the submodules 2(1) to 2(n) receive an ID number acquisition command from the CPU 10, acquire the ID numbers held in the module identification mechanisms 22(1) to 22(n), and send out the acquired ID to the CPU 10. Upon acquiring the ID numbers, the CPU 10 grasps the submodule configuration on the basis of the acquired ID numbers.

Upon grasping the submodule configuration, the CPU 10 reads the data in the memory card 24 from the head block (first block) (see FIG. 2) (step S13).

The CPU 10 determines whether the read data is the data end symbol “FEND” (see FIG. 2) (step S14).

If the data thus read is the data end symbol “FEND” (“Yes” of the step S14), the CPU 10 terminates the program write processing.

On the other hand, if the read data is not the data end symbol “FEND” (“No” of the step S14), i.e., the data is an ID number (see FIG. 2), the CPU 10 determines whether the ID number exists in the ID numbers acquired at the step S12 (step S15). In other words, the CPU 10 determines whether a module having the same ID number as the read ID number exists (the step S15).

Unless the same ID number as the read ID number exists in the ID numbers acquired at the step S12 (“No” of the step S15), the CPU 10 skips over following steps S16 and S17, and proceeds to subsequent step S18.

On the other hand, if the same ID number as the read ID number exists in the ID numbers acquired at the step S12 (“Yes” of the step S15), the CPU 10 reads the next block (the second block), i.e., the number of blocks in the body data (see FIG. 2) from the memory card 24, and stores it in the RAM 12. In addition, the CPU 10 reads a block following the second block (the third block), i.e., the version number (see FIG. 2) from the memory card 24, and compares it with the version number of the program which becomes the rewriting subject (step S16).

Specifically, if the rewriting subject is the main module 1, the CPU 10 compares the version number read out from the memory card 24 with the version number of the general control program stored in the flash memory 13 (which is included in the general control program as described earlier).

On the other hand, if the rewriting subject is the submodules 2(1) to 2(n), the CPU 10 compares the read version number with the version number of the external device control program in the flash memory 19 in the submodule 2 which becomes the rewriting subject (which is included in the external device control program as described earlier). In other words, the CPU 10 issues a version number acquisition command to each of the CPUs 16 in the submodules 2. Upon receiving the version number acquisition command, each of the CPUs 16 acquires the version number from the external device control program in the flash memory 19, and sends the version number to the CPU 10. The CPU 10 compares the version number read from the memory card 24 with the received version number.

If as a result of the comparison the version number read out from the memory card 24 is less than or equal to the version number of the program which becomes there writing subject (“No” of the step S16), the CPU 10 skips over the following step S17 and proceeds to the subsequent step S18.

On the other hand, if as a result of the comparison, the version number read from the memory card 24 is greater than the version number of the program which becomes the subject of rewriting (i.e., if the program to be newly installed is the latest) (“Yes” of the step S16), the CPU 10 implements the ensuing processing.

First, if the rewriting subject is the main module 1, the CPU 10 erases all the data in the flash memory 13, reads out main body data (see FIG. 2) corresponding to one unit (one module) from the memory card 24, and writes the main body data thus read out into the flash memory 13 (step S17). Reading the main body data corresponding to one unit is done by reading data corresponding to the number of blocks acquired at the above described step S16, beginning with the block (the fourth block) following the block storing the version number (see FIG. 2).

On the other hand, if the subject of rewriting is the submodules 2(1) to 2(n), the CPU 10 issues a program rewriting instruction to the CPU 16 in the pertinent submodule 2 (step S17). Upon receiving this instruction, the CPU 16 executes the individual write program loaded into the RAM 18 at the step S11 and implements the following processing (step S17).

In other words, first, the CPU 16 erases all the data (the external device control program and the individual write program) in the flash memory 19. Subsequently, the CPU 10 reads out the main body data (a new external device control program) (see FIG. 2) from the memory card 24, and sends the main body data to the CPU 16. Or the CPU 16 directly reads out the main body data from the memory card 24. The CPU 16 writes the main body data into the flash memory 19. Thereafter, the CPU 16 writes back the individual write program loaded into the RAM 18 into the flash memory 19. By the way, it is possible to previously store the individual write program into the memory card 24 together with the external device control program, and write the individual write program into the flash memory 19 together with the external device control program.

Upon finishing writing the programs into the flash memory, the CPU 10 sets an access pointer to the memory card 24 to the head of the next module data (the main module data or the submodule data) (see FIG. 2) (step 18), and repeats the steps S13 to S17 until the data end symbol “FEND” is read (“Yes” of the step S14).

Upon reading the data end symbol “FEND” (“Yes” of the step S14), the CPU 10 finishes the write control program. If thereafter the control apparatus is restarted, the ordinary operation mode is started. In other words, the CPU 10 executes the general control program newly written into the flash memory 13, and the CPUs 16(1) to 16(n) execute the external device control programs newly written into the flash memories 19(1) to 19(n).

In the above described program writing processing, all the data in the flash memory 19 are erased once when writing a new external device control program. Therefore, the individual write program is loaded from the flash memory 19 into the RAM 18,and executed. As an alternative method, it is also possible to provide a different memory such as an EPROM storing the individual write program in each of the submodules 2(1) to 2(n) and execute the individual write program without loading it in the RAM 18. According to this alternative method, it is not necessary to load the individual write program into the RAM 18 and write back the individual write program into the flash memory 19, and the program write processing can be executed efficiently.

Furthermore, in the above described program write processing, all the programs to be updated are erased and new programs are written. As an alternative method, the programs may be updated by rewriting parts of the programs or adding difference programs. In this case, data for partial rewriting or data to be added should be prepared in the memory card 24.

As a matter of course, the above-described program write processing can be executed even in the case where there are a plurality of submodules of the same kind in one control apparatus.

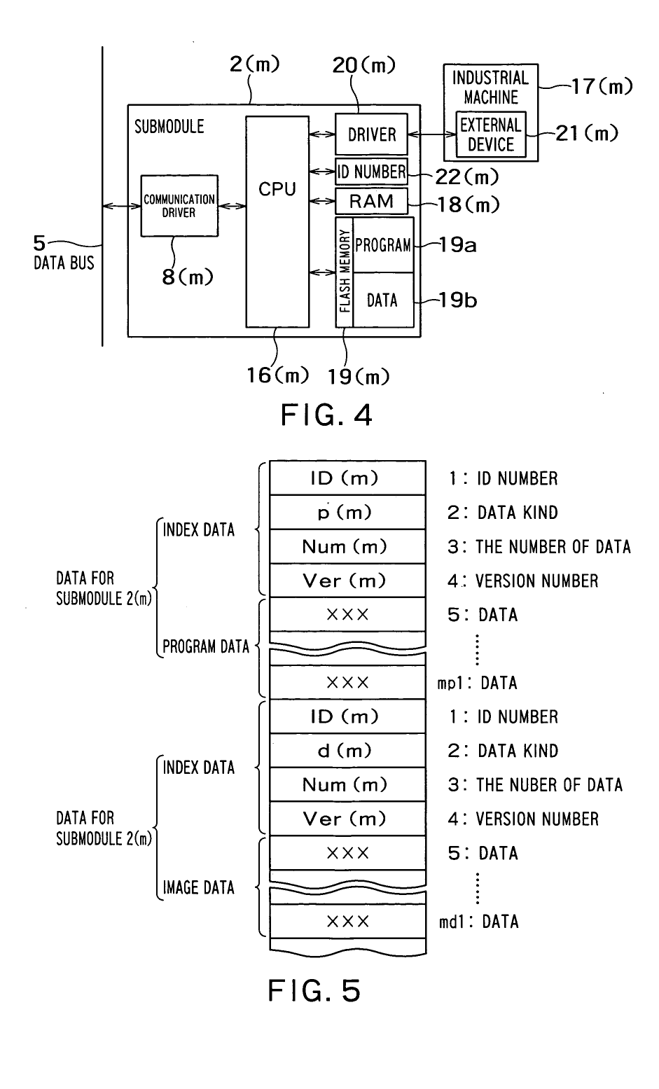

By the way, in some cases, the control apparatus displays a help view (operation view) showing how to operate the industrial machine, on a display section of the industrial machine, and gives an operation guide for the operations. In this case, data of this operation view is stored in, for example, the above described flash memory 19. As described earlier, the individual write program and the external device control program are stored in the flash memory 19. In some cases, it is desired to update the operation view data stored in the flash memory 19 or the individual write program, or both of them in such a state. In other words, in some cases, it is desired that the individual write program and the operation view data can be updated independently. To satisfy the demand in such cases, as appreciated from FIG. 4 showing an arbitrary submodule 2(m) (m=1, 2, 3 . . . n) among the submodules 2(1) to 2(n), the area of the flash memory 19(m) should be divided into a program area 19a to store the individual write program and the external device control program and a data area 19b to store image data, and one or both f the areas should be rewritten. A data structure to archive this is shown in FIG. 5.

As shown in FIG. 5, in this data structure, a symbol (data kind) to identify whether the subject of rewriting is a program or image data is stored in a block subsequent to the block of the ID number. In this example, “p” is stored in the case of a program, and “d” is stored in the case of image data. The CPU 10 executing the write control program reads this kind “p” or “d”. In the case of “p” (program), the CPU 10 writes the main body data (program) into the program area 19a in the flash memory 2(m). On the other hand, in the case where the data kind is “d” (image data), the CPU 10 writes the main body data (image data) into the data area 19b. As a result, the program and the image data can be independently rewritten respectively.

FIGS. 4 and 5 have been described by taking a submodule as an example. In the main module as well, however, the program and the image data can be independently updated respectively in the same way. While image data is stored in the data area 19b, other data such as the program version number or the like may be stored in the data area 19b instead of the program area 19a.

According to the present embodiment, a program in the main module or submodule is updated by rewriting the program stored in the flash memory. As a result, the program in the main module or submodule can be updated easily.

Furthermore, at the time of program write processing, the version number of the existing program is automatically checked. Only in the case where the new program is the latest version, this new program is written. Therefore, the management of the program version also becomes simple.

Furthermore, since the general purpose memory card is used as a medium to store data for update, it is not necessary to develop a special apparatus. For example, even if the site where the control apparatus is disposed and a division for program development are away from each other, therefore, the program and the data in the control apparatus can be updated quickly. In other words, data for write operation is sent from the development division to a personal computer disposed near the control apparatus via a network. Subsequently, the data for write operation is transferred from the personal computer to a memory card inserted into the personal computer, and this memory card is pulled out from the personal computer and is inserted into the connector of the control apparatus. Thereafter, various programs and data in the control apparatus are updated in accordance with the present embodiment described above. As a result, the work of carrying an EPROM storing new programs or the like to the site and replacing the EPROMs is not necessary unlike the conventional technique. Therefore, the programs and data can be updated quickly.

A wide variety of control apparatuses can be present according to differences of configurations of submodules. Even in that case, it is possible to use a memory card storing update data (install data) for each of control apparatuses collectively, in common with respect to each control apparatus (only data required for the control apparatuses is extracted on the basis of an ID number). Therefore, it is not necessary to prepare a memory card for each of control apparatuses, and the cost there about can be reduced.

In the present embodiment heretofore described, a memory card is used as a storage medium. Besides, however, for example, a hard disk, a magnetic disk and an optical disk or the like can also be used as a memory module.

Furthermore, in the present embodiment, data in a memory card is read by inserting the memory card in the read out drive. However, the data in the memory card may be read out via a network such as the Internet or the like.

Furthermore, in the present embodiment, the general control program and the external device control program are the subject of up dating. Besides,however,for example, the write control program and the individual write program can also be updated.

In the case where it is made possible to update the write control program, the write control program is previously stored not in the above described EPROM but in an EEPROM (Electrically Erasable Programmable Read-Only Memory) or a flash memory. And at the time of program write processing, the write control program is loaded from the EEPROM or the like into the RAM and executed, and a new write control program is read out from the memory card and is written into the EEPROM or the like.

On the other hand, in the case of update of the individual write program as well, at the time of updating, in the same way, the individual write program is loaded from the flash memory into the RAM and executed, and a new individual write program read out from the memory card is written into the flash memory.

Furthermore, in the present embodiment, programs to be written into each of the modules are incorporated in one file, and the programs in the modules are updated in the lump by using the file. In an alternative method, a file including new programs is created for every module, and a module which becomes the subject of rewriting and a file corresponding to the module can be selected by a manual mode. As a result, only programs in the selected module are rewritten to the programs in the selected file.

Furthermore, in the present embodiment, program rewriting is not implemented when the version of the program to be written is older than the version of the program which becomes the subject of rewriting. As an option of the write control program, however, a mode that makes it possible to implement writing irrespective of the version of the program (for example, even if the version is old) may also be provided. This aims at making it possible to restore the program of the previous version when a nonconformity or the like is found in the program of the updated version.

1. An control apparatus for an industrial machine comprising:
a submodule including a first memory of electrically rewritable nonvolatile type to store an industrial machine control program, the submodule executing the industrial machine control program stored in the first memory to control an industrial machine;
a read out drive reading out a data for rewriting the industrial machine control program from a memory module; and
a main module including a second memory having a rewrite control program stored therein to rewrite the industrial machine control program, and a third memory having a general control program stored therein to control the submodule, in an ordinary mode the main module executing the general control program stored in the third memory to cause the submodule to execute the industrial machine control program and control the industrial machine, in an program rewrite mode the main module executing the rewrite control program stored in the second memory to rewrite the industrial machine control program stored in the first memory, using the data read out by the read out drive.

2. The control apparatus according to claim 1,
wherein the read out drive reads out a data for rewriting the general control program from the memory module, and
in the program rewrite mode, the main module executes the rewrite control program to rewrite the general control program stored in the third memory, using the data read out by the read out drive.

3. The control apparatus according to claim 1,
wherein the read out drive reads out a data for rewriting the rewrite control program from the memory module, and
in the program rewrite mode, the main module loads the rewrite control program stored in the second memory into a RAM in the main module, and executes the rewrite control program in the RAM to rewrite the rewrite control program stored in the second memory, using the data read out data by the read out drive.

4. The control apparatus according to claim 1,
wherein the submodule includes an individual rewrite program stored in the first memory to rewrite the industrial machine control program,
in the program rewrite mode, the main module executes the rewrite control program to send a rewrite instruction to the submodule, and
the submodule executes the individual rewrite program stored in the first memory to rewrite the industrial machine control program, using the data read out by the read out drive.

5. The control apparatus according to claim 4,
wherein the read out drive reads out a data for rewriting the individual rewrite program from the memory module, and
in the program rewrite mode, the main module executes the rewrite control program to rewrite the individual rewrite program, using the data read out by the read out drive.

6. The control apparatus according to claim 1,
wherein the submodule has a submodule-identifier-holder to hold an identifier for identifying itself,
the read out drive reads out the data for rewriting the industrial machine control program associated with the identifier, from the memory module, and
in the program rewriting mode, the main module executes the rewrite control program to acquires the identifier from the submodule, and rewrites the industrial machine control program in the submodule having the acquired identifier, using the data associated with the acquired identifier read out by the read out drive.

7. The control apparatus according to claim 1, wherein the submodule includes a version-information-holder to hold version information of the industrial machine control program stored in the first memory,
the read out drive reads out the data for rewriting the industrial machine control program associated with the version information, from the memory module, and
in the program rewriting mode, the main module executes the rewrite control program to compares the version information held in the submodule with the version information included in the data read out by the read out drive, and when a result of the comparison satisfies a predetermined condition, the main module rewrites the industrial machine control program.

8. The control apparatus according to claim 1,
wherein the first memory has a program area to store the industrial machine control program and a data area to store display data to be displayed on a display section of the industrial machine,
the read out drive reads one or both of the data for rewriting the industrial machine control program (a first data) and a data for rewriting the display data (a second data) from the memory module, and
in the program rewriting mode, the main module executes the rewrite control program to rewrite one or both of the industrial machine control program in the program area and the display data in the data area, using one or both of the first data and the second data read out by the read out drive.

9. The control apparatus according to claim 8,
wherein the first data and the second data respectively include index data for identification of themselves, and
the main module discriminates the first data and the second data on the basis of the index data, and writes one or both of the first data and the second data read out by the read out drive, into one or both of the program area and the data area.

10. The control apparatus according to claim 1, wherein the submodule, the read out drive and the main module are connected to the same bus.

11. The control apparatus according to claim 1, wherein the read out drive includes a connector into which the memory module is to be inserted.

12. An industrial machine system comprising:
an industrial machine to operate predetermined processings;
a submodule including a first memory of electrically rewritable nonvolatile type to store an industrial machine control program to control the industrial machine, the submodule executing the industrial machine control program to control the industrial machine;
a read out drive reading out a data for rewriting the industrial machine control program from a memory module; and
a main module including a second memory having a rewrite control program stored therein to rewrite the industrial machine control program, and a third memory having a general control program stored therein to control the submodule, in an ordinary mode the main module executing the general control program stored in the third memory to cause the submodule to execute the industrial machine control program and control the industrial machine, in an program rewrite mode the main module executing the rewrite control program stored in the second memory to rewrite the industrial machine control program stored in the first memory, using the data read out by the read out drive.

13. The industrial machine system according to claim 12,
wherein the submodule includes an individual rewrite program stored in the first memory to rewrite the industrial machine control program,
in the program rewrite mode, the main module executes the rewrite control program to send a rewrite instruction to the submodule, and
the submodule executes the individual rewrite program stored in the first memory to rewrite the industrial machine control program, using the data read out by the read out drive.

14. The industrial machine system according to claim 12, wherein the submodule, the read out drive and the main module are connected to the same bus.

15. The industrial machine system according to claim 14, wherein the read out drive includes a connector into which the memory module is to be inserted.

16. The industrial machine system according to claim 12, wherein the industrial machine is a die casting machine, an injection molding machine or a machine tool.

17. A method of updating a program for controlling an industrial machine, comprising:
in an ordinary mode, a main module executes a general control program stored in a first memory in the main module to cause a submodule connected to the same bus as the main module to execute an industrial machine control program stored in a second memory of electrically rewritable nonvolatile type in the submodule and control an industrial machine, and
in a program rewrite mode, the main module executes a rewrite control program stored in a third memory in the main module to make a read out drive which is connected to the same bus read out a data for rewriting the industrial machine control program from a memory module, and rewrites the industrial machine control program stored in the second memory, using the data read out by the read out drive.

18. The method of updating a program for controlling an industrial machine according to claim 17,
wherein in the program rewrite mode, the main module sends a rewrite instruction to the submodule, and
the submodule executes an individual rewrite program stored in the second memory in the submodule to rewrite the industrial machine control program, using the data read out by the read out drive.
